(19) United States
(12) Patent Application Publication
(10) Pub. No.: US 2003/0229454 A1
(43) Pub. Date: Dec. 11, 2003

(54) Use of a computer to design a molecule

(76) Inventors: Ellis L. Reinherz, Lincoln, MA (US); Pedro Reche, Boston, MA (US)

Correspondence Address: FISH & RICHARDSON PC, 225 FRANKLIN ST, BOSTON, MA, 02110, US

(21) Appl. No.: 10/429,685

(22) Filed: May 5, 2003

Related U.S. Application Data
(60) Provisional application No. 60/380,055, filed on May 6, 2002.
(60) Provisional application No. 60/453,649, filed on Mar. 11, 2003.

(51) Int. Cl. G06F 19/00

(52) U.S. Cl. 702/19

(57) ABSTRACT

The invention features a computer-based method of identifying subunit immunogens useful for generating antibodies against a variety of infectious microorganisms (e.g., variola major virus). Such subunit immunogens will preferably be capable of inducing protective immunity to relevant microorganisms and the antibodies elicited by them will be useful as passive immunoprotectants.

This application claims benefit of U.S. Provisional Application Serial No. 60/380,055, filed May 6, 2002, and U.S. Provisional Application Serial No. 60/453,649, filed Mar. 11, 2003. The disclosures of U.S. Provisional Application Serial No. 60/380,055 and U.S. Provisional Application Serial No. 60/453,649 are incorporated herein by reference in their entirety.

### TECHNICAL FIELD

This invention relates to computer-based methods of designing molecules.

### BACKGROUND

In view of the human and economic devastation inflicted by infectious diseases such as malaria and tuberculosis and the potential for bioterrorists to exploit diseases such as smallpox, it is imperative that immunogens and passive immunoprotectants be developed that can be used as prophylactic and/or therapeutic agents against them.

### SUMMARY

The inventors have discovered a computer-based method for designing a compound useful for generating antibodies specific for a particular infectious microorganism. The method involves identifying open reading frames (orf) in the genome of an infectious microorganism that encode proteins expressed on the surface of the infectious microorganism. Antibodies that bind to the ectodomains of such proteins are produced. These antibodies are tested for their ability to inhibit the pathogenicity of the infectious microorganism. Antibodies that inhibit the pathogenicity are produced as passive immunoprotectants. Compounds containing the ectodomains, or portions of such ectodomains, to which the inhibitory antibodies bind are produced as vaccines.

More specifically the invention features a computer-based method of identifying an antibody that inhibits infection. The method, which requires the use of a programmed computer that contains at least a processor and an input device, includes the steps of: (a) providing the nucleic acid sequence of a plurality of open reading frames in the genome of an infectious microorganism; (b) inputting to the input device the nucleic acid sequence; (c) screening the nucleic acid sequence, using the processor, to identify an open reading frame encoding a protein that is predicted to be expressed on the surface of the infectious microorganism; (d) producing an antibody that binds to the ectodomain of the protein; and (e) determining whether the antibody inhibits the pathogenicity of the infectious microorganism. The open reading frame can be identified as encoding a protein expressed on the surface of the infectious microorganism by a process that involves detecting, in the open reading frame, a nucleotide sequence encoding a putative transmembrane region; this process can optionally further involve detecting, in the open reading frame, a nucleotide sequence encoding a putative signal sequence. Alternatively, the open reading frame can be identified as encoding a protein expressed on the surface of the infectious microorganism by detecting, in the open reading frame, a nucleotide sequence encoding a glycosylphosphatidyl inositol (GPI) linkage site. The antibody can be produced by immunizing an animal with a polypeptide containing the ectodomain of the protein or it can be produced by immunizing an animal with cells transfected or transduced with a nucleic acid encoding a polypeptide containing the ectodomain of the protein; the cells can express the polypeptide on their surfaces or they can secrete the polypeptide. Moreover, the antibody can be a monoclonal antibody or a polyclonal antibody.

The infectious microorganism can be a virus, e.g., variola major virus, variola minor virus, vaccinia virus, hepatitis virus A-E, human papilloma virus, human immunodeficiency virus 1, human T cell lymphotropic virus 1, Herpes virus, Dengue virus 1-4, Ebola virus, Marburg virus, Lassa virus, Machupo virus, or influenza virus. Alternatively, the infectious microorganism can be a bacterium, e.g., Mycobacterium tuberculosis, Mycobacterium leprae, a Salmonella bacterium (such as Salmonella typhimurium or Salmonella typhi), Yersinia pestis, Bacillus anthracis, Clostridium botulinum, Francisella tularensis, Corynebacterium diphtheriae, Vibrio cholerae, or Escherichia coli. Morover, the infectious microorganism can be a protozoan parasite, e.g., a malarial parasite or Leishmania.

The invention also embodies a process of manufacturing a compound. This process involves carrying out the above described computer-based method of identifying an antibody that inhibits infection; and, after determining that the antibody inhibits the pathogenicity of the infectious microorganism, manufacturing a compound containing at least a portion of the ectodomain. Also embraced by the invention is a compound manufactured by this process.

Yet another aspect of the invention is a method of inducing an immune response in an animal. The method includes performing steps (a)-(e) of the above-described computer-based method of identifying an antibody that inhibits infection and, after determining that the antibody inhibits pathogenicity of the infectious microorganism, administering a compound comprising at least a portion of the ectodomain to an animal susceptible to infection with the infectious microorganism. The immune response induced in the animal can be a protective immune response. The compound can be administered to the animal parenterally, intranasally, transcutaneously, or orally.

Another aspect of the invention is a process of manufacturing an antibody. The process includes carrying out the above-described computer-based method of identifying an antibody that inhibits infection and, after determining that the antibody inhibits the pathogenicity of the infectious microorganism, manufacturing the antibody. An antibody made by this process is another embodiment of the invention.

Also featured by the invention is a method of treatment. The method includes performing steps (a)-(e) of the above-described method of identifying an antibody that inhibits infection and, after determining that the antibody inhibits pathogenicity of the infectious microorganism, administering the antibody to an animal. The infectious microorganism can be a virus such as an orthopox virus, e.g., a variola virus or a vaccinia virus. The protein can be a smallpox growth factor (SPGF) or a VGF (vaccinia growth factor) and the antibody can be a monoclonal antibody or a polyclonal antibody. A monoclonal antibody can be the 3D4R-13E8 monoclonal antibody (ATCC Accession No: PTA-5040) (also referred to herein as the 13E8 monoclonal antibody) or the 3D4R-11D7 monoclonal antibody (ATCC Accession No: 5039) (also referred to herein as the 11D7 monoclonal antibody). The method can further comprise administering to the animal one or more additional antibodies, the one or more additional antibodies binding to a protein encoded by the infectious microorganism. The one or more additional antibodies can be antibodies that bind to a protein encoded by an orthopox virus (e.g., a variola virus or a vaccinia virus). The one or more additional antibodies can be the 3D4R-13E8 monoclonal antibody (ATCC Accession No.: PTA-5040) or the 3D4R-11D7 monoclonal antibody (ATCC Accession No: PTA-5039).

Also encompassed by the invention is a monoclonal antibody that binds to a protein encoded by the genome of variola virus or a vaccinia virus, the protein being a protein that is expressed on the surface of the virus or on the surface of a cell infected with the virus. The protein can be a SPGF or a VGF. The monoclonal antibody can be the 3D4R-13E8 monoclonal antibody (ATCC Accession No: PTA-5040) or the 3D4R-11D7 monoclonal antibody (ATCC Accession No: PTA-5039). Another aspect of the invention is a humanized antibody derived from any of the above monoclonal antibodies.

As used herein, a “compound” is any type of molecule, including a biological molecule such as a polypeptide, a lipid, a carbohydrate, or a nucleic acid molecule.

As used herein, an “ectodomain” of a protein is that portion of the protein that is normally located on the outer surface of the microorganism and/or attached to and projecting extracellularly from the cell membrane of a cell infected with the microorganism. “Polypeptide” and “protein” are used interchangeably and mean any peptide bond-linked chain of amino acids, regardless of length or post-translational modification.

As used herein, an expression control sequence that is “operably linked” to a coding sequence is incorporated into a genetic construct so it effectively controls expression of the coding sequence.

Unless otherwise defined, all technical and scientific terms used herein have the same meaning as commonly understood by one of ordinary skill in the art to which this invention pertains. In case of conflict, the present document, including definitions, will control. Preferred methods and materials are described below, although methods and materials similar or equivalent to those described herein can be used in the practice or testing of the present invention. All publications, patent applications, patents and other references mentioned herein are incorporated by reference in their entirety. The materials, methods, and examples disclosed herein are illustrative only and not intended to be limiting.

Other features and advantages of the invention, e.g., designing efficacious immunogens, will be apparent from the following description, from the drawings and from the claims.

### BRIEF DESCRIPTION OF THE DRAWINGS

FIG. 1 is a chart showing various characteristics of 26 proteins encoded by leader sequence-containing open reading frames in the genome of variola major virus. The first column indicates the designation of the relevant gene (“Gene”) and the GenBank identity number of the gene (“GB ID”). The second column (“Seq. Length”) shows the total number of amino acids in the immature protein. The third column (“Transmem.”) indicates: (1) whether, using TMHMM software, the relevant protein was predicted to have a transmembrane domain; and (2) for those proteins that were predicted to have a transmembrane domain, the amino acid residues (in terms of residue number) predicted to be within the transmembrane domains. The fourth column (“PDB HIT”) indicates whether a “hit” was obtained in comparing the sequence of the relevant protein to known amino acid sequences in the PDB protein data base using BLAST software; the standard name of the most significant (e≦0.01) hit protein and the name of the hit protein in swiss-prot format (“protein_species”) are shown; where a subpotimal hit (0.01<e<1) was obtained, no name is provided. The fifth column indicates whether, using PFAM software, a functional domain was detected in the relevant protein (“Domain”). Where a functional domain was detected, its PFAM designation and the number of times (“×”) the domain was predicted to occur in the protein are shown. Additional information on the relevant protein (“Annotation comments”) is provided in the sixth column.

FIG. 2 is a chart showing various characteristics of 27 proteins encoded by open reading frames in the genome of variola major virus that are predicted to contain transmembrane domain-encoding regions but not to contain leader sequences. The first column indicates the designation of the relevant gene (“Gene”) and the GenBank identity number of the gene (“GB ID”). The second column (“Seq. Length”) shows the total number of amino acids in the immature protein. The third column (“Transmem.”) indicates: (1) whether, using TMHMM software, the relevant protein was predicted to have a transmembrane domain; and (2) for those proteins that were predicted to have a transmembrane domain, the amino acid residues (in terms of residue number) predicted to be within the transmembrane domains. The fourth column (“PDB HIT”) indicates whether a “hit” was obtained in comparing the sequence of the relevant protein to known amino acid sequences in the PDB protein data base using BLAST software; the standard name of the most significant (e≦0.01) hit protein and the name of the hit protein in swiss-prot format (“protein_species”) are shown; where a subpotimal hit (0.01<e<1) was obtained, no name is provided. The fifth column indicates whether, using PFAM software, a functional domain was detected in the relevant protein (“Domain”). Where a functional domain was detected, its PFAM designation and the number of times (“×”) the domain was predicted to occur in the protein are shown. Additional information on the relevant protein (“Annotation comments”) is provided in the sixth column.

FIG. 3 is a bar chart showing the titer (in log₁₀ plaque forming units/ml (“log₁₀PFU/ml”)) of vaccinia virus in the lungs of mice nine days after injection with either a control monoclonal antibody (mice 1-5) or a pool of monoclonal antibodies (11D7, 13E8, and 7D11) (mice 6-10) and intranasal challenge with 10⁴ plaque forming units (PFU) of vaccinia virus.

FIG. 4 is a bar chart showing the titer (in log₁₀ plaque forming units/ml (“log₁₀PFU/ml”)) of vaccinia virus in the lungs of mice nine days after injection with either a control monoclonal antibody (mice 1-5), the 7D11 monoclonal antibody (mice 6-9), the 11D7 monoclonal antibody (mice 10-13), or the 13E8 monoclonal antibody (14-18), and intranasal challenge with 10⁴ plaque forming units (PFU) of vaccinia virus.

FIG. 5 is a bar chart showing the titer (in log₁₀ plaque forming units/ml (“log₁₀PFU/ml”)) of vaccinia virus in the lungs of mice nine days after the following treatments. On day 0, the mice received either no antibody (mice 1-5), an injection of a control monoclonal antibody (mice 6-10), or a pool of monoclonal antibodies (11D7, 13E8, and 7D11) (mice 11-15). All mice received an intranasal challenge with 10⁴ plaque forming units (PFU) of vaccinia virus.

FIGS. 6A and B are depictions of the amino acid sequences of small pox growth factors (SPGF) of variola major strain India (FIG. 6A) and variola major strain Bangladesh (FIG. 6B). The amino acid positions at which the two SPGF differ are shown in bold and underlined.

### DETAILED DESCRIPTION

Various aspects of the invention are described below.

Computer Hardware and Software

The invention can be implemented in computer hardware or software, or a combination of both. However, the invention is preferably implemented in one or more computer programs executing on one or more programmable computers, each containing a processor and at least one input device. The computers will preferably also contain a data storage system (including volatile and non-volatile memory and/or storage elements) and at least one output device. Program code is applied to input data to perform the functions described below and generate output information. The output information is applied to one or more output devices in a known fashion. The computer can be, for example, a personal computer, microcomputer, or work station of conventional design.

Each program is preferably implemented in a high level procedural or object oriented programming language to communicate with a computer system. However, the programs can be implemented in assembly or machine language, if desired. In any case, the language can be a compiled or interpreted language.

Each computer program is preferably stored on a storage medium or device (e.g., ROM or magnetic diskette) readable by a general or special purpose programmable computer. The computer program serves to configure and operate the computer to perform the procedures described herein when the program is read by the computer. The method of the invention can also be implemented by means of a computer-readable storage medium, configured with a computer program, where the storage medium so configured causes a computer to operate in a specific and predefined manner to perform the functions described herein.

For example, the computer-requiring steps in a method of designing an immunogenic compound can minimally involve:

(a) inputting into an input device, e.g., through a keyboard, a diskette, or a tape, the nucleotide sequence of a plurality of orf in the genome of an infectious microorganism; and

(b) screening the nucleic acid sequence, using a processor, to identify an orf encoding a protein that is expressed on the surface of the infectious microorganism.

The method can optionally involve the additional step of outputting to an output device, for example, the nucleotide sequence of an orf encoding a protein is expressed on the surface of the infectious microorganism or the amino acid sequences such a protein. In addition, the nucleotide or amino acid sequences can optionally be compared to a computer database of, for example, other nucleotide or amino acid sequences stored in a data storage system.

Genomic Nucleic Acid Sequences

A nucleic acid sequence to be analyzed by the method of the invention can be of a complete genome or of a plurality of genes in a genome. The genome can be that of any of a large number of infectious microorganisms. The nucleic acid can be DNA or RNA, depending on the microorganism being studied. Microorganisms of interest include viruses (e.g., DNA viruses and RNA viruses such as retroviruses), bacteria, mycoplasmas, fungi (including yeasts), and protozoan parasites. Hosts infected by these microorganisms can be any of wide range of mammals (e.g., humans, non-human primates (e.g., monkeys or chimpanzees), horses, goats, sheep, pigs, cows, dogs, cats, rabbits, guinea pigs, rats, mice, hamsters, or gerbils), birds (e.g., chickens or turkeys), or fish (e.g., salmon or trout).

The full or partial genomes of multiple infectious microorganisms are publicly available in, for example, databases accessible by the internet or in scientific publications.

Examples of such databases include that of the National Center for Biotechnology Information (Bethesda, Md.) and EMBL (Heidelberg, Germany).

The complete genome sequences of at least 818 different viruses are presently publicly available. Viruses of interest with respect to the methods of the invention whose complete genomic sequences are publicly available include, to name a few, variola major virus, variola minor virus, vaccinia virus, Ebola virus, Marburg virus, human poliovirus, human papilloma virus, Dengue virus (types 1-4), hepatitis A virus, hepatitis B virus, hepatitis C virus, hepatitis D virus, hepatitis E virus, monkeypox virus, Herpes viruses (e.g., Herpes Simplex virus), human T cell lymphotropic virus types 1 and 2, multiple strains of human immunodeficiency virus, types 1 and 2, swinepox virus, camelpox virus, and fowlpox virus.

Examples of bacteria and mycoplasmas whose genomic nucleotide sequences are publicly available include, without limitation, Haemophilus influenzae KW20, Mycoplasma genitalium G-37, Synechocystis sp. PCC6803, Mycoplasma pneumoniae M129, Helicobacter pylori 26695, Helicobacter pylori J99, Borrelia burgdorferi B31, Mycobacterium tuberculosis M37Rv, Mycobacterium tuberculosis CDC 1551, Treponema pallidum subs. pallidum Nichols, Chlamydia trachomatis serovar D, Chlamydia trachomatis MoPn Nigg, Rickettsia prowazekii Madrid E, Chlamydia pneumoniae CWL029, Chlamydia pneumoniae AR39, Chlamydia pneumoniae J138, Ureaplasma urealyticum serovar 3, Campylobacter jejuni NCYC 11168, Neisseria meningitidis MC58, Neisseria meningitidis Z2491 (serogroup A), Xylella fastidiosa CVC 8.1.b clone 9.a.5.c, Vibrio cholerae serotype 01 Biotype E1 Tor, strain N16961, Pseudomonas aeroginosa PA01, Mycobacterium leprae TN, Pasteurella multocida Pm70, Staphylococcus aureus M315, Staphylococcus aureus Mu50, Mycoplasma pulmonis, Streptococcus pneumoniae TIGR4, Clostridium acetobutylicum ATCC 824D, Sinorhizobium meliloti 1021, Streptococcus pneumoniae R6, Rickettsia conorii Malish 7, Yersinia pestis C92 Biovar Orientalis, Salmonella typhi CT18, Salmonella typhimurium LT2, SGSC412, Listeria monocytogenes EGD-e, Brucella melitensis 16M, and Clostridium perfringens 13.

With respect to protozoan parasites, the nucleotide sequences of chromosome 1 of Leishmania major Friedlin and of chromosomes 2 and 3 of Plasmodium falciparum 3D7 are publicly available.

It is understood that, since nucleic acid sequencing is familiar to and readily accomplished by those skilled in the art, the method of the invention is applicable to the analysis of genomes or portions of genomes whose nucleic acid sequences may be elucidated in the future. Thus, in addition to the infectious microorganisms listed above, the method of the invention can be applied to the analysis of orf of, for example, influenza virus, measles virus, rabies virus, Lassa virus, Machupo virus, Salmonella enteriditis, Bacillus anthracis, Actinobacillus pleuropneumoniae, Yersinia enterocolitica, Clostridium botulinum, Corynebacterium diphtheriae, Vibrio cholerae, Escherichia coli, Francisella tularensis, Bordetella pertussis, Porphyromonas gingivalis, Histoplasma capsulatum, Cryptococcus neoformans, Candida albicans, and Toxoplasma gondii.

Of particular interest are the smallpox (variola major and variola minor) and cowpox (vaccinia) viruses. These viruses are large double-stranded DNA viruses that replicate in the cytoplasm of infected cells. Variola virus enters subjects through the respiratory tract; human-human transmission usually occurs as a result of coughing out of virus in oralpharyngeal secretions. The incubation period is 7-19 days, followed by fever, headache and backache. After 2-3 days, the fever falls and a rash appears on the face, trunk, and extremities and progresses to vesicles, pustules and scabs lasting for several weeks. Variola major infection is fatal in approximately 40% of unvaccinated human beings. Death is primarily due to internal bleeding (disseminated intravascular coagulation) and vascular collapse. Infection with variola minor results in a less severe form of smallpox with reduced fatality.

Since international eradication of smallpox in about 1980 vaccination has ceased. Thus, smallpox protection has not been provided in the United States for approximately 20 years. As a result, a large proportion of the population has never been vaccinated against smallpox. Moreover, there are presently inadequate reserves of smallpox vaccine (attenuated vaccinia virus) in the United States and what is available was produced by a poorly controlled process which yielded live vaccinia virus capable of adversely affecting immunodeficient (e.g., AIDS and cancer) patients. In addition, 10-20 second generation cases can result from a single human infection with variola. These factors make variola virus, and particular variola major virus, an obvious choice as a bioweapon against the population of the United States. Thus it is imperative that an efficient, safe smallpox vaccine that can be mass-produced in a relatively short time be generated as quickly as possible.

Also, of interest, for example, are vaccines against malarial parasites. The ability of radiation-attenuated sporozoites of Plasmodium (the protozoan genus that causes malaria) to induce sterile protective anti-malarial immunity in murine and primate models (including man) and the ability of antibodies from semi-immune individuals to partially protect against infection indicate the possibility of developing malaria-specific vaccines. As the blood stage of malaria is most responsible for clinical pathology and red blood cells lack major histocompatibility complex (MHC) class I and class II molecules, induction of antibody (rather than cytotoxic T lymphocyte) responses to blood stage antigens is key to establishing immunity to the parasite. Thus, proteins of greatest interest for the purposes of the invention would be those that, in addition to being expressed on the surface of the parasite and cells (e.g., red blood cells) infected with parasite, are expressed primarily at the blood stage of malaria.

Proteins Expressed on the Surface of Infectious Microorganisms

In the method of the invention, the nucleic acid sequence of the genome, or a part of the genome, of an infectious microorganism of interest is scanned to identify open reading frames encoding proteins that would be expressed on the surface of the microorganism. As used herein, a part of a genome contains at least two (e.g., at least: three; four; five; six; seven; eight; nine; ten; 12; 15; 20; 25; 30; 35; 40; 50; 75; 100; 150; 200; 300; 400; 500; 1,000; 2,000; 5,000; 10,000; or more) orf.

As used herein, “proteins expressed on the surface of a microorganism” are proteins that are anchored to the lipid bilayer of the microorganism's cell membrane, where the microorganism is, for example, a bacterium, a fungus, a mycoplasma, or a protozoan, or envelope, where the microorganism is a virus. It is understood that the invention is not limited to the analysis of the nucleic acid sequences of lipid bilayer-enveloped viruses. Thus, for example, some viruses that do not have outer lipid bilayers nevertheless have open reading frames encoding poteins that would be expressed as components of the cell membranes of cells infected with the relevant viruses. Such cells would be targeted by antibodies specific for the ectodomains of the appropriates proteins. The proteins can be anchored to the cell membranes of infected cells by any of the mechanisms described below, e.g., transmembrane or glyocophosphatidyl inositol linkage domains. Importantly, in this regard, the QQIVE 1 protein of influenza contains a transmembrane domain.

Such proteins are targets of choice for the development of vaccines because of their accessibility to antibodies in infected hosts. In addition, at least some surface proteins are likely to be involved in one or more steps of the infectious process (e.g., binding to receptors on potential host cells or to molecules that facilitate their movement from one body compartment to another). Antibodies that bind to such functional surface proteins can inhibit relevant steps of the infectious process. Moreover, at least some proteins expressed on the surface of an infectious microorganism are likely also to be expressed on the surface of cells infected with the infectious microorganism, especially in the case of viruses. Thus, not only would the infectious microorganism itself be targeted by antibodies that bind to such proteins, cells infected with the infectious microorganism would also be so targeted, thereby providing an additional level of protection from infection.

Also of interest are microbially encoded proteins that are initially expressed on the surface of cells infected with relevant infectious microorganisms but subsequently either are shed into the environment of the cells or their extracellular domains are cleaved from the rest of the proteins and are released into the environment of the cells. Examples of such proteins include variola major strain India D1L and vaccinia C11R (see Examples 3 and 4). It is understood that microbial proteins that are actively secreted by cells infected with relevant infectious microorganisms (i.e., proteins having signal peptides but no means for attachment to cell surface membranes) are also molecules of importance for the invention. Microbially encoded proteins expressed on the surface of infected cells, or those released from infected cells (by any of the above-described mechanisms), can act indirectly to enhance the process of infection by relevant microorganisms by activating cells in which such organisms can replicate. Such cell activation can be, for example, activation of DNA, RNA, and/or protein synthesis or cell proliferation. Many infectious microorganisms either require such cell activation in order to replicate or replicate substantially more efficiently in activated cells than in non-activated cells. Thus antibodies that bind to any of these microbial molecules, which, via their cell-activating potential, indirectly enhance microbial pathogenesis, are also expected to be useful in inhibiting the pathogenicity of relevant infectious microorganisms.

While scanning the genomic nucleic acid sequence can be done by inspecting it with the naked eye, it is preferably done with the aid of a computer (see above).

Class I membrane proteins (i.e., proteins in which the ectodomain is at the N-terminus) expressed on the surface of microorganisms will generally occur in an immature form with a signal peptide encoded by a leader sequence at the 5′ end of the orf. The signal peptide is cleaved from the immature protein to create the mature form, which is inserted in the lipid bilayer of microorganism's envelope or cell membrane. Thus, genomic nucleic acid sequences can initially be screened for orf containing such signal sequences. Signal sequences are well-known in the art [Gierasch (1989) Biochem. 28:923], as are methods for identifying them. Computer programs useful for the identification of signal sequences include SIGNALIP [Nielsen et al. (1997), Protein Eng. 10:1].

In addition, many proteins expressed on the surface of microorganisms can be identified by the presence of a domain that anchors the protein to the surface of the microorganism. Thus, a surface protein can have, for example, a relatively hydrophobic transmembrane domain that anchors the protein in lipid bilayers. Alternatively, a surface protein can be attached to the outer surface of a cell membrane by a glycosylphosphatidyl inositol (GPI) linkage. Transmembrane and GPI linkage domains are known in the art, as are ways of identifying nucleic acid sequences encoding them. GPI-linked proteins exist as immature proproteins from which a relatively hydrophobic C-terminal propeptide (of about 10-20 amino acids) is cleaved to create the mature protein. The GPI moiety is then attached to the C-terminal residue of the mature protein by a transamidation reaction that occurs in the endoplasmic reticulum. The C-terminal residue of the mature protein is frequently either Ser, Asp, Asn, Ala, or Gly in protozoa and either Ser, Gly, Asn, or Asp in metazoa. There is a relatively polar spacer region of about 8-12 amino acids N-terminal of the C-terminal residue of the mature protein. GPI linkages are described in greater detail in Eisenhaber et al. [(1988) Prot. Eng. 1155-1161], which is incorporated herein by reference in its entirety.

Thus, orf identified as encoding proteins having signal peptides can be further screened for the presence of nucleotide subsequences encoding transmembrane domains and amino acid motifs through which a GPI linkage is formed. Computer programs useful for the identification of nucleotide sequences encoding transmembrane domains include TMHMM [Sonhammer et al. (1998), A hidden Markov model for predicting transmembrane helices in protein sequences. In, Sixth International Conference on Intelligent Systems for Molecular Biology. J. Glasgow et al., eds. AAAI Press, Menlo Park, Calif. p. 175] and Tmpred [Hofmann et al. (1993) Biol. Chem. Hoppe-Seyler 374:166]. Computer programs useful for the identification of nucleotide sequences encoding GPI domains include PSORT [Nakai et al. (1992) Genomics 14:897] and Big-PI Predictor [Eisenhaber et al. (1992) J. Mol. Biol. 292(3):741].

It is understood that analyses to identify orf nucleotide subsequences encoding transmembrane domains or GPI-linkage domains can be done without first screening for orf having signal sequences. Indeed, Class II membrane proteins (i.e., membrane proteins in which the ectodomains are at the C-termini) do not occur as immature proproteins with cleavable signal peptides and only contain transmembrane domains.

In addition, further analyses to predict the function of proteins encoded by orf in the microorganism's genomic nucleic acid sequences can optionally be performed.

Identification of a protein's function can be useful in predicting, for example, whether the protein is expressed on the surface of the infectious microorganism. Analyses used to predict the function of a protein include: (1) comparing the amino acid sequence of the protein in question to the amino acid sequences of other proteins with known functions; (2) comparing the predicted tertiary structure of the protein to the tertiary structures of other proteins with known functions; and (3) identifying domains in the protein having a known function. Analysis (1) can be performed using, for example, BLAST, FASTA, or Smith-Waterman, software to compare a test amino sequence to known amino acid sequences in protein data bases, e.g., the NR or Swiss Protein data bases [Altschul et al. (1997) Nucl. Acids Res. 25:3389; Pearson (1990) Methods Enzymol. 183:63; Shpaer et al. (1996) Genomics 38(2):179]. Analysis (2) can be performed using, for example, BLAST searches combined with threading and/or folding recognition algorithms. Examples of software useful for analysis (3) include SMART [Schultz et al. (2000) Nucl. Acids Res. 28:3389] and PFAM [Bateman et al. (2000) Nucl. Acids Res. 28:231].

Having identified by the above methodologies proteins of an infectious microorganism of interest that are expressed on the surface of the relevant infectious microorganism, one can readily identify the ectodomain of the protein, i.e., the region of the protein on the surface of the microorganism or projecting externally from the cell membrane of a cell infected with the microorganism. In the case of a protein containing, for example, a transmembrane domain, the ectodomain of the protein would be the region N-terminal or C-terminal of the transmembrane domain, depending on whether the protein is a Class I transmembrane protein or Class II transmembrane protein, respectively. On the other hand, if the protein is attached to the surface of the infectious microorganism by a GPI linkage, the entire amino acid sequence of the protein is extracellular. It is then possible to perform the steps of the method of the invention described below.

Producing Antibodies that Bind to the Ectodomain of a Surface Protein of an Infectious Microorganism

In the method of the invention, having identified a protein that is expressed on the surface of an infectious microorganism of interest, one or more antibodies that bind to the ectodomain of a surface protein are produced. The term “ectodomain fragment” as used herein refers to the whole ectodomain or a portion of the ectodomain. Such antibodies are produced by immunizing animals with an ectodomain fragment (see below). Alternatively, animals can be immunized with full-length proteins and antibodies from such animals that bind to appropriate ectodomains can be identified by any of a variety of methods known in the art. The antibody produced can be a polyclonal antibody present in, for example, the serum or plasma of animals (e.g., humans, non-human primates, mice, rabbits, rats, guinea pigs, hamsters, sheep, horses, goats, cows, pigs, or birds) that have been immunized with the relevant ectodomain fragment using methods, and optionally adjuvants, known in the art. Polyclonal antibodies can be isolated from serum or plasma by methods also known in the art.

Monoclonal antibodies that bind to the ectodomain can also be produced in the method of the invention. Methods of making and screening monoclonal antibodies are well known to those skilled in the art. Once the desired antibody-producing hybridoma has been selected and cloned, the resultant antibody can be produced by any of a number of methods known in the art. For example, the hybridoma can be cultured in vitro in a suitable medium for a suitable length of time, followed by the recovery of the desired antibody from the supernatant. The length of time and medium are known or can be readily determined.

Immunizing animals against the ectodomain fragment of interest for the purposes of making polyclonal and/or monoclonal antibodies can be achieved by, for example, making and isolating the ectodomain fragment using, for example, recombinant methods (see below) and injecting the animals with the ectodomain fragment. Alternatively, animals can be immunized with a nucleic acid encoding an ectodomain fragment using any of a number of methods known in the art. For doses, routes, and frequency of injection and useful adjuvants, see the section below on Methods of Inducing an Immune Response. Screening assays to test for the ability of antibodies in, e.g., body fluids (e.g., blood) from immunized animals or hybridoma culture supernatants to bind to ectodomains of interest are known in the art and include methods such as ELISA or immunoblotting.

Alternatively, rather than immunizing animals with the ectodomain fragment per se, they can be immunized with recombinant cells transfected or transduced with an expression vector containing a nucleic acid sequence encoding the ectodomain fragment. The nucleic acid sequence in the expression vector encoding the ectodomain fragment is designed so that the ectodomain fragment is expressed on the surface of, or secreted by, cells transfected or transduced with the expression vector. Cells used for transfection or transduction will preferably be syngeneic with the animal to be immunized. Prior to injection, the recombinant cells can be metabolically inhibited (by, for example, exposure to ionizing radiation) so as to prevent proliferation of the cells in the animal after injection.

Antibodies (polyclonal or monoclonal) produced after such immunization can be tested for their ability to bind specifically to the relevant ectodomain using assays such as ELISA or immunoblotting assays. Alternatively, they can be tested for their ability to bind to the recombinant cells used for immunization; the same cells not expressing the ectodomain fragment on their surfaces (e.g., non-transduced or non-transfected cells or cells transduced or transfected with a control expression vector not containing the ectodomain fragment coding sequence) can optionally be used as negative controls. Antibodies that bind to the recombinant cells, but not to the negative control cells, are presumably antibodies that bind to the ectodomain fragment. Such antibodies can then be tested for their ability to inhibit the pathogenicity of the relevant infectious microorganism (see below).

Polyclonal and monoclonal antibodies that bind to an ectodomain of interest, and preferably inhibit pathogenicity of a relevant microorganism can be manufactured in large amounts by methods known in the art. Thus, in the case of polyclonal antibodies, large animals (e.g., sheep, pigs, goats, horses, or cows) or a large number of small animals can be immunized as described above. Serum can be isolated from the blood of animals producing an antibody with the desired activity. If desired, polyclonal antibodies can be purified from such sera by methods known in the art.

Monoclonal antibodies can be produced in large amounts in vitro using, for example, bioreactors or in vivo by injecting appropriate animals with the relevant hybridoma cells. For example, mice or rats can be injected intraperitoneally (i.p.) with the hybridoma cells, and after a time sufficient to allow substantial growth of the hybridoma cells and secretion of the monoclonal antibody into the blood of the animals, they can be bled and the blood used as a source of the monoclonal antibody. If the animals are injected i.p. with an inflammatory substance (such as pristane) as well as the hybridoma cells, peritoneal exudates containing the monoclonal antibodies develop in the animals. The peritoneal exudates can then be “tapped” from the animals and used as a source of the appropriate monoclonal antibody.

Recombinant antibodies specific for ectodomain fragments, such as chimeric and humanized monoclonal antibodies comprising both human and non-human portions, are also within the scope of the invention. Such chimeric and humanized monoclonal antibodies can be produced by recombinant DNA techniques known in the art, for example, using methods described in Robinson et al., International Patent Publication PCT/US86/02269; Akira et al., European Patent Application 184,187; Taniguchi, European Patent Application 171,496; Morrison et al., European Patent Application 173,494; Neuberger et al., PCT Application WO 86/01533; Cabilly et al., U.S. Pat. No. 4,816,567; Cabilly et al., European Patent Application 125,023; Better et al. (1988) Science 240, 1041-43; Liu et al. (1987) J. Immunol. 139, 3521-26; Sun et al. (1987) PNAS 84, 214-18; Nishimura et al. (987) Canc. Res. 47, 999-1005; Wood et al. (1985) Nature 314, 446-49; Shaw et al. (1988) J. Natl. Cancer Inst. 80, 1553-59; Morrison, (1985) Science 229, 1202-07; Oi et al. (1986) BioTechniques 4, 214; Winter, U.S. Pat. No. 5,225,539; Jones et al. (1986) Nature 321, 552-25; Veroeyan et al. (1988) Science 239, 1534; and Beidler et al. (1988) J. Immunol. 141, 4053-60.

Also within the scope of the invention are antibody fragments and derivatives that contain at least the functional portion of the antigen-binding domain of an antibody that binds specifically to ectodomain fragments. Antibody fragments that contain the binding domain of the molecule can be generated by known techniques. Such fragments include, but are not limited to: F(ab′)₂ fragments that can be produced by pepsin digestion of antibody molecules; Fab fragments that can be generated by reducing the disulfide bridges of F(ab′)₂ fragments; and Fab fragments that can be generated by treating antibody molecules with papain and a reducing agent. See, e.g., National Institutes of Health, 1 Current Protocols In Immunology, Coligan et al., ed. 2.8, 2.10 (Wiley Interscience, 1991). Antibody fragments also include Fv fragments, i.e., antibody products in which there are few or no constant region amino acid residues. A single chain Fv fragment (scFv) is a single polypeptide chain that includes both the heavy and light chain variable regions of the antibody from which the scFv is derived. Such fragments can be produced, for example, as described in U.S. Pat. No. 4,642,334, which is incorporated herein by reference in its entirety.

Antibodies that bind to ectodomain fragments of interest have multiple uses. They can be used, for example, to identify or purify the relevant microbial protein. They can also be employed in assays (e.g., ELISA or immunoblotting assays) to detect or measure the level of such proteins in samples of interest. Moreover, they can be used as positive controls in assays to detect antibodies that bind to the relevant protein or ectodomain fragment of the protein. Antibodies that not only bind to the ectodomain fragment but inhibit pathogenicity of the relevant infectious microorganism are useful not only for the above purposes, but also (a) for decreasing or eliminating growth of the relevant microorganism in vitro; and (b) as in vivo passive immunoprotectants (see below).

Applicants have deposited under the Budapest Treaty the 3D4R-11D7 and 3D4R13E8 hybridomas with the American Type Culture Collection (ATCC), Rockville, Md. 20852, U.S.A. The 3D4R-11D7 hybridoma was assigned the ATCC accession no. PTA-5039 and the 3D4R-13E8 hybridoma the ATCC accession no. PTA-5040. The hybridomas deposited with the ATCC were taken from a deposit maintained by the Dana Farber Cancer Institute, Inc., since prior to the priority date of this application. The deposits of hybridomas will be maintained without restriction in the ATCC depository for a period of 30 years, or five years after the most recent request, or for the effective life of the patent, whichever is the longer, and will be replaced if the deposit becomes non-viable during that period.

Tests for the Ability to Inhibit the Pathogenicity of an Infectious Microorganism

As used herein, a substance (e.g., an antibody or a polypeptide that is part of a surface protein of an infectious microorganism) that “inhibits the pathogenicity of an infectious microorganism” is a substance that inhibits any step in the infectious process of the microorganism. Thus, the substance can inhibit, for example, replication (intracellular or extracellular) of the infectious microorganism, binding of the infectious microorganism to the surface of a cell, entry of the infectious microorganism into a cell, binding of the infectious microorganism to an extracellular matrix molecule, activation of cells in which the infectious microorganism can replicate. Moreover, the substance can reverse, partially or completely, the subversion of normal immune mechanisms by microbial proteins that, for example, mimic receptors for soluble factors (e.g., cytokines) required for effective immune responses (e.g., see Example 1); such receptor mimics can bind the relevant soluble factors and thereby compete with natural receptors on cells of the immune of the immune system for binding to the soluble factors. Where the substance is an antibody, it can also inhibit pathogenicity of an infectious microorganism by, for example: facilitating phagocytosis of the infectious microorganism by macrophages, monocytes, or granulocytes; inducing complement-mediated lysis of the microorganism or a cell infected with the microorganism; eliciting antibody-dependent cell-mediated cytolysis (ADCC) of the infectious microorganism or a cell infected with the microorganism; or block pathogenic effects resulting from cellular activation and/or immune evasion.

Tests for inhibition of pathogenicity can be in vitro or in vivo. In vitro tests for the ability of a substance to inhibit replication of a microorganism are known in the art. In brief, samples containing a plurality of the microorganisms and, if appropriate host cells, are incubated with the substance at one or more concentrations for one or more pre-established periods of time. The replicative activity of the microorganism can be assessed by techniques such as direct counting of the number of microorganisms in the samples (or aliquots of the samples), colony-forming assays performed on aliquots of the samples, viral-plaque assays, DNA synthesis (e.g., ³H-thymidine incorporation) assays, or the like. Replicative activity can be measured in samples containing and not containing the test substance and the degree of inhibition by the test substance determined by comparing these values.

Substances of interest can be tested for their ability to inhibit in vivo infection by a relevant infectious microorganism. The test substance can be administered (at one or more doses) to test animals (e.g., any of those listed above) before, after, or at the same time that the infectious microorganism is administered to the animals. The test substance and the infectious microorganism can be administered once or multiply (e.g., two times, three times, four times, five times, six times, seven times, eight times, nine times, ten times, or even more frequently). The test animals can be observed for pathologic symptoms familiar to those in the art, e.g., malaise, lack of appetite, morbidity and mortality. Alternatively, they can be euthanized at various time points and samples of their body fluids (e.g., blood, urine, lymph, mucus, saliva, or cerebrospinal fluid), tissues (e.g., lung, liver, spleen, brain, spinal cord, kidney, or intestine), or feces may be assayed for relative levels of the infectious microorganism by methods known to artisans of ordinary skill, such as the in vitro assays described above. The data obtained with the test animals can be compared to those obtained with a control group of animals, e.g., animals that were exposed to the diluent in which the test compound was dissolved or suspended (e.g., physiological saline). Increased resistance of the test animals to infection, relative to the control animals, would indicate that the test substance is an effective inhibitor of pathogenicity for the purposes of the instant invention.

In vitro neutralization assays familiar to those in the art can also be performed to test for infectious agent-specific neutralizing activity in test substances. Where the test substances are antibodies, they can be tested for their ability to promote phagocytosis, complement-mediated lysis or ADCC by methods known to those skilled in the art.

Compounds of the Invention and Polypeptides Useful for the Invention

Once a protein that is expressed on the surface of an infectious microorganism has been identified, an ectodomain fragment of the protein can be tested for its ability to inhibit the pathogenicity of the infectious microorganism e.g., its ability to inhibit replication of a virus. Inhibitory activity of the ectodomain fragment would indicate that the protein from which the ectodomain was derived acts to promote infection by the infectious microorganism. An ectodomain fragment with this inhibitory activity can then be subjected to any of a variety of structural analyses (e.g. x-ray crystallographic analysis) aimed at determining how the relevant protein ectodomain acts to promote infection by the microorganism. Appropriate structural analyses (including x-ray crystallographic analyses) are described in detail in co-pending International Application No. PCT/US02/25263, whose disclosure is incorporated herein by reference in its entirety.

In addition, once ectodomain fragments are identified that elicit the production of, and bind to, antibodies that inhibit the pathogenicity of the relevant infectious microorganism, compounds containing, or consisting of, the ectodomain fragments are produced as immunogens to be used for activating immune responses in animals (see below). In view of the above definition of ectodomain fragments, it is understood that an ectodomain fragment can be the entire ectodomain, or a portion of the ectodomain, of the protein. Such ectodomain fragments can also be subjected to structural analyses aimed at designing compounds that have the three-dimensional structure of a subregion of the relevant protein as the subregion occurs in the active conformation of the protein, i.e., the conformation of the protein in which it mediates an activity that promotes infection by the microorganism, e.g., binding of the microorganism to a cellular receptor. These types of structural analyses are described in detail in co-pending International Application No. PCT/US02/25263. Compounds identified in this way could elicit the production of antibodies that are particularly effective at prophylaxis against and/or therapy of infection by an appropriate infectious microorganism.

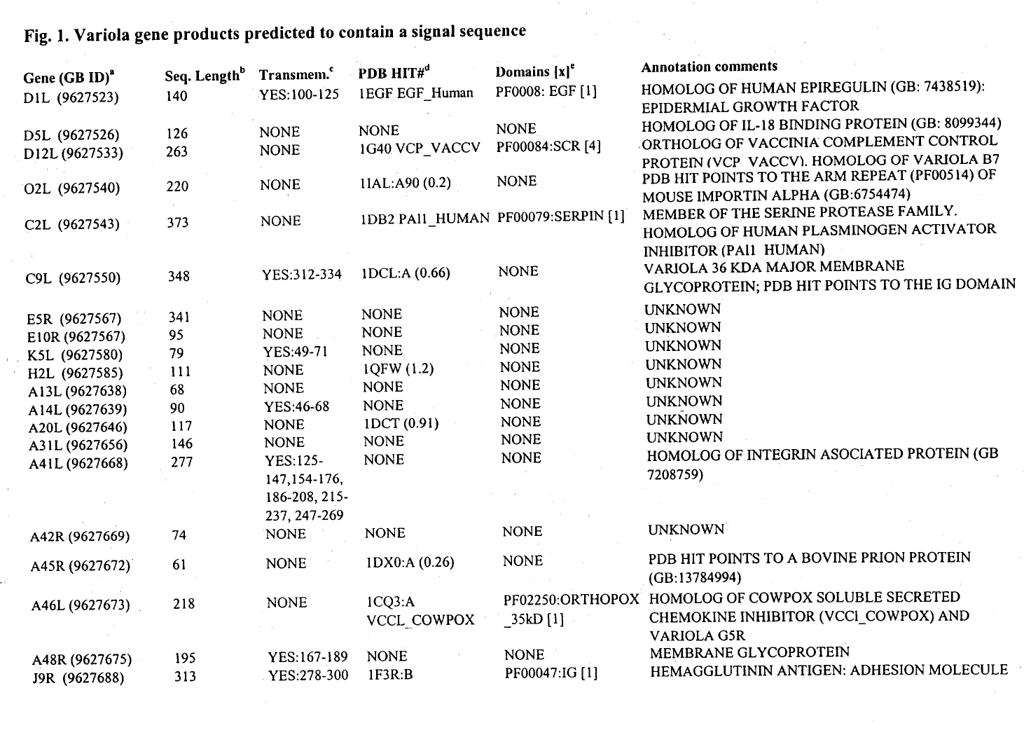

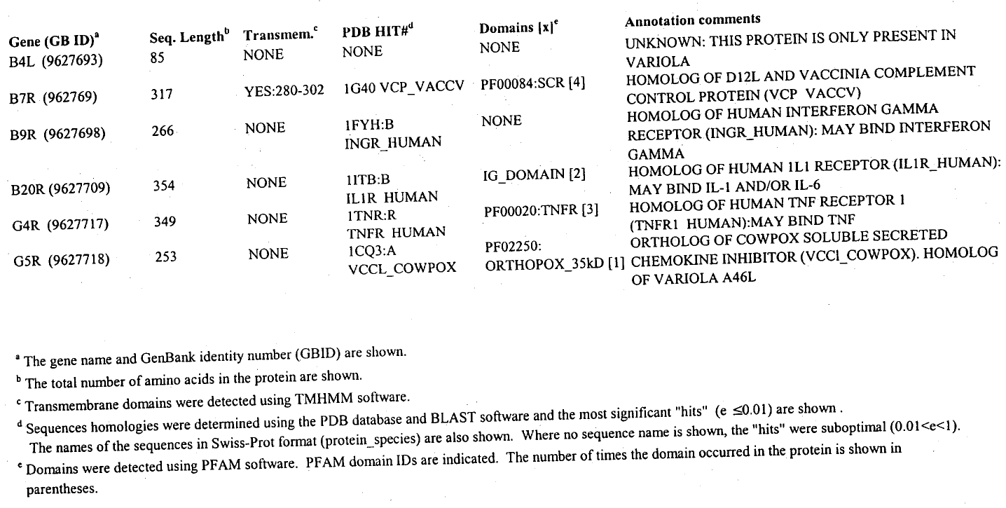

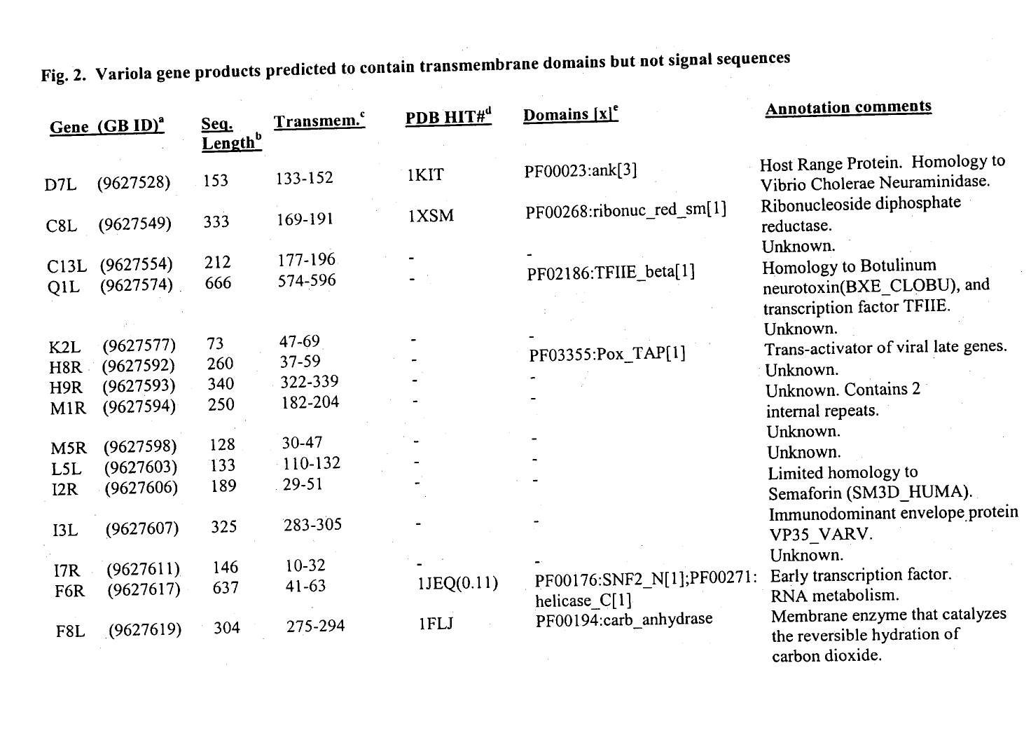

The invention includes all the above-described compounds. Specific examples of such compounds include the ectodomains, or fragments of the ectodomains, of all the proteins listed in FIGS. 1 and 2 that have transmembrane domains. The amino acid sequences of these ectodomains, and the nucleotide sequences of DNA encoding the ectodomains, can readily be obtained from information provided in FIGS. 1 and 2, including the GenBank identity numbers. The disclosure of the appropriate GenBank postings are incorporated herein by reference in their entirety.

The compounds of the invention can include, in addition to the above described immunogenic domains, one or more domains that facilitate purification (e.g., poly-histidine sequences) or domains that serve to direct the compound to organs of the immune system, e.g., ligands or antibodies (including antibody fragments such Fab, F(ab′)₂, or single chain Fv fragments) specific for cell surface components of cells of the immune system, e.g., the F1t3 ligand or antibodies specific for CD4, CD8, CD3, CD2, CD19, or CD20. Other useful domains include immune stimulatory cytokines (e.g., without limitation, interleukin (IL)-2, IL-4, IL-5, IL-6, IL-10, IL-13), adjuvant molecules (e.g., cholera toxin or E. coli heat labile toxin) or functional fragments of such molecules, i.e., those retaining at least some, e.g., at least 10%, 20%, 30%, 40%, 50%, 60%, 70%, 80%, 90%, or all, of the activity of the parent molecule, or at least the receptor-binding activity. All that is required in such multidomain compounds is that the immunogenic domain retains the 3-D structure it would have in the absence of the additional domains. Conjugation to make such multidomain compounds can be by chemical methods (e.g., Barrios et al. (1992) Eur. J. Immunol. 22:1365-1372]. Where a compound of the invention is a fusion protein, it can be produced as part of a recombinant protein, such as one that self-assembles into virus-sized particles (e.g., U.S. Pat. No. 4,918,166) that display the immunogenic peptide on the surface.

Compounds of the invention include those described above, but modified for in vivo use by the addition, at the amino- and/or carboxyl-terminal ends, of a blocking agent to facilitate survival of the relevant polypeptide in vivo. This can be useful in those situations in which the peptide termini tend to be degraded by proteases prior to cellular uptake. Such blocking agents can include, without limitation, additional related or unrelated peptide sequences that can be attached to the amino and/or carboxyl terminal residues of the peptide to be administered. This can be done either chemically during the synthesis of the peptide or by recombinant DNA technology by methods familiar to artisans of average skill.

Alternatively, blocking agents such as pyroglutamic acid or other molecules known in the art can be attached to the amino and/or carboxyl terminal residues, or the amino group at the amino terminus or carboxyl group at the carboxyl terminus can be replaced with a different moiety. Likewise, the peptide compounds can be covalently or noncovalently coupled to pharmaceutically acceptable “carrier” proteins prior to administration.

Also of interest are peptidomimetic compounds that are designed based upon the amino acid sequences of polypeptides of the invention that are peptides. Peptidomimetic compounds are synthetic compounds having a three-dimensional conformation (i.e., a “peptide motif”) that is substantially the same as the three-dimensional conformation of a selected peptide. The peptide motif provides the peptidomimetic compound with the ability to elicit the production of antibodies cross-reactive with a selected peptide. Peptidomimetic compounds can have additional characteristics that enhance their in vivo utility, such as increased cell permeability and prolonged biological half-life.

The peptidomimetics typically have a backbone that is partially or completely non-peptide, but with side groups that are identical to the side groups of the amino acid residues that occur in the peptide on which the peptidomimetic is based. Several types of chemical bonds, e.g., ester, thioester, thioamide, retroamide, reduced carbonyl, dimethylene and ketomethylene bonds, are known in the art to be generally useful substitutes for peptide bonds in the construction of protease-resistant peptidomimetics.

The ectodomain fragments used in the method of the invention and the compounds of the invention containing ectodomain fragments of interest can be produced by a variety of means. For example, they can be purified from natural sources (e.g., from any of the infectious microorganisms listed herein). Smaller peptides (fewer than 100 amino acids long) can be conveniently synthesized by standard chemical means known to those in the art. In addition, both the ectodomain fragments and the compounds of the invention can be manufactured by standard in vitro recombinant DNA techniques and in vivo transgenesis using nucleotide sequences encoding the appropriate polypeptides or peptides (see Nucleic Acids section below). Methods well-known to those skilled in the art can be used to construct expression vectors containing relevant coding sequences and appropriate transcriptional/translational control signals. See, for example, the techniques described in Sambrook et al., Molecular Cloning: A Laboratory Manual (2nd Ed.) [Cold Spring Harbor Laboratory, N.Y., 1989], and Ausubel et al., Current Protocols in Molecular Biology [Green Publishing Associates and Wiley Interscience, N.Y., 1989].

For the methods of the invention, it is generally required that the ectodomain fragments and the compounds and antibodies of the invention be highly purified. Methods for purifying biological macromolecules (e.g., proteins) are known in the art. The degree of purity of any of these proteins can be measured by any appropriate method, e.g., column chromatography, polyacrylamide gel electrophoresis, or HPLC analysis.

Nucleic Acids

The invention also includes nucleic acids encoding the compounds of the invention (see above). Nucleic acid molecules encoding both ectodomain fragments and the compounds of the invention can be useful for making the ectodomain fragments and compounds of the invention. For example, they can be used for producing the ectodomain fragments used to immunize animals for the production of antibodies (see above). The nucleic acid molecules can be cDNA, genomic DNA, synthetic DNA, or RNA, and can be double-stranded or single-stranded (either a sense or an antisense strand). Segments of these molecules are also considered within the scope of the invention, and can be produced by, for example, the polymerase chain reaction (PCR) or generated by treatment with one or more restriction endonucleases. A RNA molecule can be produced by in vitro transcription. Preferably, the nucleic acid molecules encode polypeptides that, regardless of length, are soluble under normal physiological conditions.

The nucleic acid molecules can contain naturally occurring sequences, or sequences that differ from those that occur naturally, but, due to the degeneracy of the genetic code, encode the same polypeptide. In addition, these nucleic acid molecules are not limited to coding sequences, e.g., they can include some or all of the non-coding sequences that lie upstream or downstream from a coding sequence.

The nucleic acid molecules can be synthesized (for example, by phosphoramidite-based synthesis) or obtained from a biological cell such as a mammalian cell (e.g., a cancer cell) or a virus e.g., variola or vaccinia virus.

In addition, the nucleic acid molecules of the invention and those useful for the invention include segments that are not found as such in the natural state. Thus, the invention encompasses recombinant nucleic acid molecules (for example, an isolated nucleic acid molecule encoding a compound of the invention) incorporated into a vector (for example, a plasmid or viral vector) or into the genome of a heterologous cell (or the genome of a homologous cell, at a position other than the natural chromosomal location). Recombinant nucleic acid molecules and uses therefor are discussed further below.

The invention also encompasses: (a) vectors (see below) that contain any of the sequences encoding the polypeptides of the invention; (b) expression vectors that contain any of the foregoing coding sequences operably linked to any transcriptional/translational regulatory elements (examples of which are given below) necessary to direct expression of the coding sequences; and (c) genetically engineered host cells (see below) that contain any of the foregoing expression vectors and thereby express the nucleic acid molecules of the invention.

Suitable vectors include plasmids and viral vectors such as herpes viruses, retroviruses, vaccinia viruses, attenuated vaccinia viruses, canary pox viruses, adenoviruses and adeno-associated viruses, among others.

The transcriptional/translational regulatory elements referred to above and further described below include, but are not limited to, inducible and non-inducible promoters, enhancers, operators and other elements that are known to those skilled in the art and that drive or otherwise regulate gene expression. Such regulatory elements include but are not limited to the cytomegalovirus hCMV immediate early gene, the early or late promoters of SV40 adenovirus, the lac system, the trp system, the TAC system, the TRC system, the major operator and promoter regions of phage A, the control regions of fd coat protein, the promoter for 3-phosphoglycerate kinase, the promoters of acid phosphatase, and the promoters of the yeast α-mating factors.

The expression systems that may be used for purposes of the invention include but are not limited to microorganisms such as bacteria (for example, E. coli and B. subtilis) transformed with recombinant bacteriophage DNA, plasmid DNA, or cosmid DNA expression vectors containing the nucleic acid molecules of the invention; yeast (for example, Saccharomyces and Pichia) transformed with recombinant yeast expression vectors containing the nucleic acid molecule of the invention; insect cell systems infected with recombinant virus expression vectors (for example, baculovirus) containing the nucleic acid molecule of the invention; plant cell systems infected with recombinant virus expression vectors (for example, cauliflower mosaic virus (CaMV) or tobacco mosaic virus (TMV)) or transformed with recombinant plasmid expression vectors (for example, Ti plasmid) containing a polypeptide-encoding nucleotide sequence; or mammalian cell systems (for example, COS, CHO, BHK, 293, VERO, HeLa, MDCK, W138, and NIH 3T3 cells) harboring recombinant expression constructs containing promoters derived from the genome of mammalian cells (for example, the metallothionein promoter) or from mammalian viruses (for example, the adenovirus late promoter and the vaccinia virus 7.5K promoter). Also useful as host cells are primary or secondary cells obtained directly from a mammal and transfected with a plasmid vector or infected with a viral vector.

Cells transfected or transduced with the expression vectors of the invention can then be used, for example, for large or small scale in vitro manufacture of an ectodomain fragment or for another polypeptide of the invention by methods known in the art. In essence, such methods involve culturing the cells under conditions that maximize production of the polypeptide and isolating the polypeptide from the culture, i.e., from the cells and/or from the culture medium.

Methods of Inducing an Immune Response

The invention features methods of activating immune responses in which cells of the immune system are exposed to one or more compounds of the invention.

The methods of the invention can be performed in vitro or in vivo. In vitro application of the compounds of the invention can be useful, for example, in basic scientific studies of immune mechanisms or for the production of antibodies, e.g., for use in studies on infection or cancer or for passive immunoprotection. In vitro activation with the compounds of the invention can also be used to obtain activated B lymphocytes useful for deriving monoclonal antibody- producing cell lines (e.g., human antibody-producing cell lines or hybridomas).

In the in vitro methods of the invention, lymphoid cells (including T and B lymphocytes) obtained from a mammalian subject are cultured with a compound of the invention. The lymphoid cells can be from a subject pre-exposed to the compound, to the protein from which the compound was derived, or to the infectious microorganism that naturally produces the protein; alternatively, the donor of the lymphoid cells need not have been exposed to any of these entities. The cultures can be “restimulated” as often as necessary with either the compound, the ectodomain fragment, or the protein. The cultures can also be monitored at various times to ascertain whether the desired level of immune reactivity (e.g., antibody production or CD4+ helper T cell activity) has been attained.

The compounds of the invention are generally useful for generating immune responses and as prophylactic vaccines or immune response-stimulating therapeutics. It is understood that the responses elicited by the compounds need have neither prophylactic nor therapeutic efficacy. They can be used, for example, (a) to elicit large quantities of antibodies in animals (e.g., rabbits, goats, sheep, or horses) that are subsequently isolated from the animals and used for purposes such as antigen detection or purification, or (b) for immunization of animals (e.g., mice, rats, guinea pigs, or hamsters) with a view to making monoclonal antibodies.

The compounds can also be used, for example, as vaccines or therapeutic agents against infectious diseases associated with any of the infectious microorganisms listed herein.

As used herein, “prophylaxis” can mean complete prevention of the symptoms of a disease, a delay in onset of the symptoms of a disease, or a lessening in the severity of subsequently developed disease symptoms. “Prevention” means that symptoms of the disease (e.g., an infection) are essentially absent. As used herein, “therapy” can mean a complete abolishment of the symptoms of a disease or a decrease in the severity of the symptoms of the disease. As used herein, a “protective” immune response is an immune response that is prophylactic and/or therapeutic.

The methods of the invention can be applied to any of the subjects listed above.

In one in vivo approach, the compound itself is administered to the subject. Generally, the compounds of the invention will be suspended in a pharmaceutically-acceptable carrier (e.g., physiological saline) and can be administered orally, transdermally, intrarectally, intravaginally, intranasally, intragastrically, intratracheally, or intrapulmonarily, or injected (or infused) intravenously, subcutaneously, intramuscularly, or intraperitoneally. They can be delivered directly to an appropriate lymphoid tissue (e.g. spleen, lymph node, or mucosal-associated lymphoid tissue (MALT)). The dosage required depends on the route of administration, the nature of the formulation, the nature of the patient's illness, the subject's size, weight, surface area, age, and sex, other drugs being administered, and the judgment of the attending physician. Suitable dosages are in the range of 0.01-100.0 mg/kg. Wide variations in the needed dosage are to be expected in view of the variety of compounds available and the differing efficiencies of various routes of administration. For example, oral administration would be expected to require higher dosages than administration by intravenous injection. Variations in these dosage levels can be adjusted using standard empirical routines for optimization, as is well understood in the art. Administrations can be single or multiple (e.g., 2- or 3-, 4-, 6-, 8-, 10-, 20-, 50-, 100-, 150-, or more fold). Encapsulation of the compounds in a suitable delivery vehicle (e.g., polymeric microparticles or implantable devices) may increase the efficiency of delivery, particularly for oral delivery.

If desired, booster immunizations may be given once or several (two, three, four, eight or twelve, for example) times at various times (e.g., spaced one week apart). The compounds of the invention can be administered alone or with adjuvant, e.g., cholera toxin (CT), E. coli heat labile toxin (LT), mutant CT (MCT) [Yamamoto et al. (1997) J. Exp. Med. 185:1203-1210] and mutant E. coli heat labile toxin (MLT) [Di Tommaso et al. (1996) Infect. Immunity 64:974-979]. MCT and MLT contain point mutations that substantially diminish toxicity without substantially compromising adjuvant activity relative to that of the parent molecules. Other useful adjuvants include alum, Freund's complete and incomplete adjuvant, and RIBI.

Antibody (e.g., IgG, IgM, or IgA) responses specific for the compound or for the ectodomain fragment from which the compound was derived can then be measured by testing for the presence of such antibodies systemically (e.g., in serum) or, for example, at various mucosal sites (e.g., in saliva or gastric and bronchoalveolar lavages) using in vitro assays familiar to those in the art, e.g., ELISA. Alternatively, or in addition, since CD4+ T cell responses are generally required for antibody responses, in vitro CD4+ T cell responses to the test compound and/or the relevant ectodomain fragment can be measured using methods known in the art. Such methods include CD4+ T cell proliferation or lymphokine (e.g., interleukin-2, interleukin-4, or interferon-γ) production assays. In addition, in vivo skin tests can be performed on the animals. Such assays test for both antibodies and pre-activated CD4+ T cells specific for the test antigen. A positive response within 12 hours is indicative of an antibody response, while a response that is optimal between 48 and 96 hours indicates the presence of CD4+ T cells that have previously been exposed to the relevant antigen. The frequency of administration can be as indicated above in the section describing methods for determining the immunogenicity of the compounds of the invention.

Alternatively, a polynucleotide containing a nucleic acid sequence encoding a compound of interest can be delivered to an appropriate cell of the animal. Expression of the coding sequence will preferably be directed to lymphoid tissue of the subject by, for example, delivery of the polynucleotide to the lymphoid tissue. This can be achieved by, for example, the use of a polymeric, biodegradable microparticle or microcapsule delivery vehicle, sized to optimize phagocytosis by phagocytic cells such as macrophages. For example, PLGA (poly-lacto-co-glycolide) microparticles approximately 1-10μ in diameter can be used. The polynucleotide is encapsulated in these microparticles, which are taken up by macrophages and gradually biodegraded within the cell, thereby releasing the polynucleotide. Once released, the DNA is expressed within the cell. A second type of microparticle is intended not to be taken up directly by cells, but rather to serve primarily as a slow-release reservoir of nucleic acid that is taken up by cells only upon release from the micro-particle through biodegradation. These polymeric particles should therefore be large enough to preclude phagocytosis (i.e., larger than 5μ and preferably larger than 20μ).

Another way to achieve uptake of the nucleic acid is using liposomes prepared by standard methods. The vectors can be incorporated alone into these delivery vehicles or co-incorporated with tissue-specific antibodies. Alternatively, one can prepare a molecular conjugate composed of a plasmid or other vector attached to poly-L-lysine by electrostatic or covalent forces. Poly-L-lysine binds to a ligand that can bind to a receptor on target cells [Cristiano et al. (1995), J. Mol. Med. 73, 479]. Alternatively, lymphoid tissue-specific targeting can be achieved by the use of lymphoid tissue-specific transcriptional regulatory elements (TRE) such as a B lymphocyte, T lymphocyte, or dendritic cell specific TRE. Lymphoid tissue specific TRE are known [Thompson et al. (1992), Mol. Cell. Biol. 12, 1043-1053; Todd et al. (1993), J. Exp. Med. 177, 1663-1674; Penix et al. (1993), J. Exp. Med. 178, 1483-1496]. Delivery of “naked DNA” (i.e., without a delivery vehicle) to an intramuscular, intradermal, or subcutaneous site is another means to achieve in vivo expression.

In the relevant polynucleotides (e.g., expression vectors), the nucleic acid sequence encoding the compound with an initiator methionine and optionally a targeting sequence is operatively linked to a promoter or enhancer-promoter combination.

Polynucleotides can be administered in a pharmaceutically acceptable carrier. Pharmaceutically acceptable carriers are biologically compatible vehicles that are suitable for administration to a human or other mammalian subject, e.g., physiological saline. A therapeutically effective amount is an amount of the polynucleotide that is capable of producing a medically desirable result (e.g., an antibody response) in a treated animal. As is well known in the medical arts, the dosage for any one patient depends upon many factors, including the patient's size, body surface area, age, the particular compound to be administered, sex, time and route of administration, general health, and other drugs being administered concurrently. Dosages will vary, but a preferred dosage for administration of polynucleotide is from approximately 10⁶ to 10¹² copies of the polynucleotide molecule. This dose can be repeatedly administered, as needed. Routes and frequency of administration can be any of those listed above.

Passive Immunoprotection

As used herein, “passive immunoprotection” means administration of one or more protective antibodies to a subject that has been exposed, or is at risk of being exposed, to an infectious microoganism, e.g., variola virus. Thus, passive immunoprotection can be prophylactic and/or therapeutic. The antibodies can be administered by any of the routes disclosed herein, but will generally be administered intravenously, intramuscularly, or subcutaneously. For a human subject, the antibody can be a “humanized” version of a monoclonal antibody originally generated in a different species. They can be administered to any of the species listed herein. The antibodies will preferably, but not necessarily, be of the same species as the subject to which they are administered. A single polyclonal or monoclonal antibody can be administered, or two or more (e.g., two, three, four, five, six, seven, eight, nine, ten, 12, 14, 16, 18, or 20) polyclonal antibodies or monoclonal antibodies can be given. Where more than one antibody is administered, the different antibodies can have the ability to bind to one ectodomain fragment or different ectodomain fragments, each derived from the same protein or different proteins. It is understood that when more than one antibody is administered, the antibodies can be specific for either the same infectious microorganism or different infectious microorganisms. It is possible, for example, that the subject to which such antibodies are administered had been exposed to more than one (e.g., two, three, four, five, six, seven, eight, nine, or ten) different infectious microorganisms. The antibodies can be any of those disclosed herein.

The antibodies can be administered to subjects prior to, subsequently to, or at the same time as the compounds of the invention or nucleic acids encoding the compounds of the invention.

The dosage of antibody required depends on the route of administration, the nature of the formulation, the nature of the patient's illness, the subject's size, weight, surface area, age, and sex, other drugs being administered, and the judgment of the attending physician.

Suitable dosages are in the range of 0.01-100.0 mg/kg. Wide variations in the needed dosage are to be expected in view of the variety of antibodies available and the differing efficiencies of various routes of administration. Variations in these dosage levels can be adjusted using standard empirical routines for optimization, as is well understood in the art.

Administrations can be single or multiple (e.g., 2- or 3-, 4-, 6-, 8-, 10-, 20-, 50-, 100-, 150-, or more fold).

The above-described vaccination and passive immunotherapeutic methods can be applied to infections by any of the microorganisms listed herein. Methods to test whether a compound or antibody is therapeutic for, or prophylactic against, a particular disease are known in the art. Where a therapeutic effect is being tested, a test population displaying symptoms of the disease (e.g., smallpox) is treated with a test compound or antibody of the invention, using any of the above described strategies. A control population, also displaying symptoms of the disease, is treated, using the same methodology, with a placebo.

Disappearance or a decrease of the disease symptoms in the test subjects would indicate that the compound or antibody was an effective therapeutic agent.

By applying the same strategies to subjects prior to onset of disease symptoms, the compounds and antibodies can be tested for efficacy as prophylactic agents, i.e., vaccines. In this situation, prevention of onset of disease symptoms is tested.

The following examples are meant to illustrate, not limit, the invention.

### EXAMPLES

### Example 1

### Bioinformatic Analysis of the Variola Major Virus Genome

Variola is one of the largest and most complex of double-stranded DNA viruses and is visible by light microscopy. Sequence data are available on variola major viruses and variola minor virus. Current sequence data for variola in GenBank include: (a) five nucleotide sequence entries and 626 amino acid sequence entries for variola major; and (b) three nucleotide sequence entries and 619 amino acid sequence entries for variola minor. There are two complete variola major genome nucleotide sequences, corresponding to strain India 1967 (GI:9627521; 185,578 bp) and strain Bangladesh (GI:623595; 186,103 bp), and one complete genome nucleotide sequence of variola minor strain Alastrim (GI:5830555; 186,986 bp) available in GenBank. Comparison of the variola major and variola minor genomes shows that they are over 97% identical throughout the entire genome. Likewise, comparison of any of the variola genomes with that of vaccinia (GI:9790357; 191,737 bp) indicates that they are ˜95% identical.

There are 197 genes in the genome of variola major strain India 1967 (GI:9627521). Very little is known about their function and relevance in the life cycle of the virus. It seems likely that those proteins of variola that are secreted or membrane-anchored are critical for the virus-host interactions. Virtually all proteins of the secretory pathway, in any organism, contain signal sequences that are cleaved off when the protein is translocated through the membrane [Gierasch (1989) Biochem. 28:923].

The 197 genes of variola major strain India were screened for those having an orf containing a signal sequence, using SIGNALIP software [Nielsen et al. (1997), supra]. This approach identified 26 orf encoding proteins that are either bound to the viral lipid bilayer on the surface of the virus or secreted from cells infected with the virus (FIG. 1). Further analysis of those 26 orf using TMHMM software [Sonnhammer et al. (1998), supra] identified those having nucleotide subsequences encoding transmembrane anchors. Analysis with PSORT software [Nakai et al. (1992), supra] provided other predictors of protein localization in eukaryotic cells, including GPI-linked anchors.

A similar analysis identified an additional 27 orf encoding proteins predicted to have transmembrane domains but no signal sequences (FIG. 2). These proteins are likely Class II membrane proteins.

Three approaches were then used for functional annotation of these 53 variola major genes (listed in FIGS. 1 and 2): 1) sequence similarity comparisons; 2) structural homology analysis; and 3) domain structure analysis. For sequence similarity, searches using BLAST software [Altschul et al. (1997), supra] against NR and Swiss protein databases were performed. Proteins that share significant primary sequence identity likely have similar functions [Pearson et al. (1996) Meth. Enzymol. 266:227-258]. Structural homology is noteworthy because related protein folds imply a limited set of biologic functions [Schultz et al. (2000) Nucl. Acids Res. 28:231]. BLAST searches of PDB databases and/or threading or folding recognition algorithms can be used to establish structural homology between proteins. Domain structure analysis is informative as well because proteins have a modular architecture, and protein function is linked to protein domain composition. Both SMART software [Schultz et al. (2000), supra] and PFAM software [Bateman et al. (2000) Nucl. Acids Res. 28:263] are useful for domain structure analysis. FIGS. 1 and 2 summarize various properties of the protein products of the 53 genes obtained using the above-described transmembrane domain, sequence similarity, structural homology and domain structure analyses.

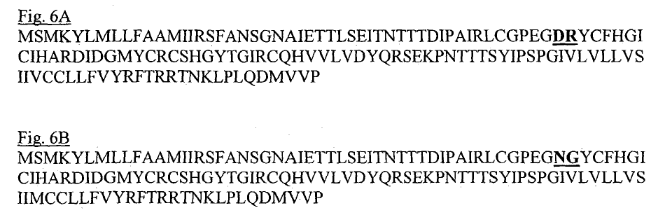

First, ˜15% of variola proteins appear to be secreted and/or membrane-anchored (i.e., have leader peptides encoded by signal sequences). Although not shown, all are present in vaccinia as well, and are highly conserved, accounting to a large extent for why vaccinia infection affords protection against variola. FIGS. 1 and 2 show that there are several proteins that, since they have transmembrane domains, are likely expressed on the surface of the virus particle and thus may be critical for variola virus binding to human cells. These include five proteins of note: DIL, C9L, A48R, J9R, and B7R (FIG. 1). D1L (of variola major strain India) is an epidermal growth factor (EGF)-like membrane-bound protein with ±97% homology to corresponding molecules of other variola strains, 86-89% identity with the corresponding vaccinia protein, and 30% identity to human epiregulin. For convenience, these orthopox (e.g., variola and vaccinia) EGF-like membrane-bound proteins are referred to herein collectively as epiregulin-like growth factors (ELGF); those proteins from variola strains are referred to herein collectively as smallpox growth factors (SPGF) and those from vaccinia strains as vaccinia growth factors (VGF). In FIGS. 6A and B are shown the amino acid sequences of SPGF from two variola strains, i.e., D1L from variola major India (FIG. 6A) and D4R from variola major Bangladesh (FIG. 6B). Note that these two SPGF differ at only two amino acid positions (indicated in bold and underlined in FIGS. 6A and B). Human epiregulin binds to several members of the EGF receptor family and inhibits the growth of several epithelial tumor cell lines but stimulates the proliferation of fibroblasts [Komurasaki et al. (1997) Oncogene 15:2841]. Interestingly, the vaccinia homologue of human epiregulin, the human ortholog of variola SPGF genes, is known to bind to the same receptors [King et al. (1986) Mo. Cell Biol. 6:332]. It seems probable that SPGF are initially expressed on the surface of cells infected with variola and that the extracellular domains are subsequently cleaved from the rest of the proteins and released into the extra-cellular environment. C9L is a 36 kDa membrane protein with a single Ig-like domain with no known human homology. A48R is a conserved membrane glycoprotein of unknown structure. J9R is another transmembrane protein with a single Ig domain followed by a stalk region suggesting an adhesion-type function. B7R is a complement control protein (CCP) with four concatamerized CCP domains and 26% identity to the F13B human protein. Thus, based on gene analysis and annotation, D1L, C9L, A48R, J9R and B7R are five candidate proteins that potentially facilitate entry of variola major virus into cells or indirectly enhance infectivity by, for example, activating cells in which the virus can replicate.

Other proteins of interest include those with homology to natural immune system receptors. Thus, for example, D5L is a homologue of IL-18-binding protein, D12L and B7R are homologues of complement control proteins, B9R is a homologue of interferon-γ receptors, and B20R is homologue of the IL-1 receptor family (FIG. 1). These variola dummy immune system receptors can function to bind the relevant soluble immune system ligands. By so doing, the variola dummy immune system receptors deplete the level of soluble immune system ligands available for binding to appropriate natural immune system receptors and prevent or substantially diminish immune system signaling. In this way the variola dummy receptors can facilitate viral escape from protective immune mechanisms.

### Example 2

### Expression of Viral Proteins

D1L, C9L, A48R, J9R and B7R are all glycoproteins. Hence, either entire ectodomains or, in the case of C9L and J9R, single Ig-like domains are over-expressed in CHO-Lec3.2.8.1 cells using a system that produces glycoproteins with homogeneous glycan adducts (GlcNac2-Man5). PCR-based methodologies are used to clone cDNA encoding each protein ectodomain, or fragment thereof, in the pEE14-GS expression vector [Liu et al. (1996) J. Biol. Chem. 271:332] with an appended N-terminal tag (e.g., FLAG or HA). Such tags enable detection of the tagged protein, for example, on the surface of cells using antibodies that bind to the tags. Expression of each protein is by means of a glutamine synthetase vector in Lec3.2.8.1 cells as used previously for over-expression of the N15 T cell receptor (TCR). Screening for high producers is performed using a sandwich ELISA [Liu et al. (1996) J. Biol. Chem. 271:332; Crowther (1995) ELISA: Theory and Practice. Humana Press, Totowa, N.J.]. Large scale production and purification are carried out as described previously for TCR, MHC class II, and CD4 molecules [Liu et al. (1996), supra; Xiong et al. (1998) EMBO J. 17:10]. Following purification by standard techniques, the protein is used to produce monoclonal antibodies (see below).

In addition, each purified protein can be sent to the Centers for Disease Control and Prevention (CDC) to test for its ability to block variola infection of human cells. Variola neutralization assays are known in the art [e.g., Phillpotts et al. (2000) Acta Virol. 44(3):151]. Samples are tested individually or in combination over a range of concentrations (about 10 ng-1 mg per ml) for their ability to block variola infection of human cells. Those proteins having inhibitory activity are then subjected to x-ray crystallographic structural analysis with a view to analyzing the mechanisms by which the proteins act to facilitate entry of the variola virus into cells. For methods of x-ray crystallographic analysis, see co-pending International Application No. PCT/US02/25263, which is incorporated herein by reference in its entirety.

### Example 3

### Neutralizing Monoclonal Antibody Development

Following protein production and purification, monoclonal antibodies (mAbs) that bind to the described ectodomains or ectodomain fragments are generated by standard hybridoma cell production employing BALB/c mice and intraperitoneal (i.p) immunization with the relevant proteins in complete Freund's adjuvant (CFA), followed by i.p. boosting with the proteins in incomplete Freund's adjuvant (IFA) [Reinherz et al. (1979) Proc. Natl. Acad. Sci. USA 76:4061]. Alternative methods include multiple subcutaneous immunization with protein in phosphate buffered saline (PBS) (without adjuvant) into foot pads and the base of tail. If the first type of immunization is employed, spleen cells are used for cell fusion, and if the second type of immunization is used, regional lymph cells are used for cell fusion. Hybridomas are screened for production of antibodies that bind to the relevant ectodomains by, for example, ELISA and immunoblotting using the recombinant proteins used for immunization.

Yet another method of immunizing mice is to multiply inject BALB/c mice i.p. with irradiated syngeneic A20 B cell lymphoma cells stably transfected with an expression vector containing and expressing a cDNA insert encoding an ectodomain fragment of interest. The cDNA insert is designed so that the ectodomain fragment is either expressed on the surface of the transfected A20 cells or is secreted by the A20 cells. Thus, if the ectodomain fragment is to be expressed on the surface of the A20 cells, the cDNA insert includes, for example, a transmembrane domain-encoding sequence and, in the case of a Class I transmembrane protein, a leader sequence; instead of a transmembrane domain-encoding sequence, the cDNA insert could contain a sequence encoding a GPI linkage domain. If on the other hand, the ectodomain fragment is to be secreted by the A20 cells, the cDNA insert includes a leader sequence but neither a transmembrane domain-encoding sequence nor a GPI-linkage domain-encoding sequence. Such leader sequences, transmembrane domain-encoding sequences, and GPI-linkage domain-encoding sequences can be sequences from the gene encoding the protein of interest or from other genes; alternatively, the sequences can be artifical sequences. mAb produced by this immunization are initially screened with transfected A20 cells expressing the ectodomain on their surfaces and those mAb that bind to the transfectants are tested for their ability to bind parent, non-recombinant A20 cells. mAb that bind to the recombinant but not to the non-recombinant A20 cells are mAb specific for the relevant ectodomain fragment.

Surface plasmon resonance binding analysis is employed for epitope mapping and kinetic analysis of protein binding [Xiong et al. (2001), supra]. In this regard, prior studies have shown that specific locale and biophysical parameters of antibody binding are critical determinants of neutralization. Those mAbs with highest affinity for each epitope are purified and provided to the CDC (see above) for neutralization assays. Antibodies that block variola infection are then produced in large amounts for use as a universal variola immune globulin (VIG), with or without mAb humanization. In addition, compounds consisting of, or containing, relevant ectodomains (or fragments thereof) that elicited the production of mAbs that inhibited variola infection of cells are manufactured as immunogens for generating antibodies that bind to variola major virus, and preferably provide protective immunity to smallpox. Moreover, the mAbs can be employed (in conjunction with, for example, PCR) in smallpox diagnostic assays. Finally, Fab fragments of neutralizing Abs can be complexed to relevant proteins to aid with crystallization of the proteins by altering molecular surfaces. The crystallized proteins can then be used in studies aimed at analyzing the mechanisms by which the proteins are involved in variola infection of cells (see above) [Wang et al. (1998) EMBO J. 17:10].

### Example 4

### Monoclonal Antibodies that Bind to ELGF Inhibit Viral Replication in vivo

An immunogen consisting of the extracellular epidermal growth factor (EGF)-like domain of the SPGF D4R was generated and used to immunize mice, which were in turn used as sources of lymphocytes for the production of monoclonal antibody-secreting hybridomas using standard well-known techniques (see Example 3). Hybridomas secreting monoclonal antibodies that bound to D4R were identified by ELISA using the recombinant D4R EGF domain used for immunization of the mice. The monoclonal antibodies (11D7 and 13E8) produced by two separate hybridomas were chosen for further study.

Both monoclonal antibodies are of the IgG2b subclass and bind to both D4R and C11R (a vaccinia ortholog of variola SPGF) with nanomolar affinity. As determined by BiaCore 3000 analysis, 13E8 binds to D4R with a dissociation constant (Kd ) of 1.3 nM and to C11R with a Kd of 13 nM. 11D7 has similar affinity for both proteins. Both monoclonal antibodies cross-block the other's binding to the two molecules; this finding implies that the epitopes to which the two antibodies bind are overlapping or at least spatially close. Separate studies (see co-pending U.S. Provisional Application No. 60/453,651) have shown that D4R (like C11R) binds to the cell-surface erbB1 epidermal growth factor receptor (EGFR) and thereby activates the tyrosine kinase activity of erbB1. This activation of erbB1 tyrosine kinase activity ultimately results in proliferation, or enhanced proliferation, of cells to which the D4R has bound. In that viruses generally replicate more efficiently in activated (e.g., dividing) cells than in non-activated cells, the cell-activating activity of ELGF is likely at least one mechanism by which it acts as a variola virulence factor and antibodies that bind to ELGF are likely to inhibit orthopox virus (e.g., variola and vaccinia) replication. Furthermore, cell signaling involving tyrosine phosphorylation subsequent to attachment of vaccinia intracellular mature virions (IMV) to cell-surface membranes facilitates entry of the IMV into the cells [Locker et al. (2000) Mol. Biol. Cell 11:2497-2511].

The 13E8 and 11D7 monoclonal antibodies both block binding of D4R and C11R to erbB1-expressing cells and thereby inhibit activation of tyrosine kinase activity in cells exposed to D4R or C11R. Most importantly, as indicated by the three experiments described below, the monoclonal antibodies, when pooled with a monoclonal antibody (7D11) specific for another vaccinia protein (L1R), inhibited in vivo replication of vaccinia virus more efficiently than when the 7D11 was used alone. The 7D11 antibody was obtained from Dr. A. L. Schmaljohn (United States Army Medical Research Institute for Infectious Diseases, Fort Detrick, Md). L1R is a protein expressed on intracellular mature vaccinia virions (IMV) (see, for example, Hooper et al. (2000) Virology 266:329-339) and ELGF (e.g., D4R and C11R) are expressed in extracellular enveloped virions (EEV) and are shed from the latters' surface. In smallpox, the predominant, if not exclusive, form of variola that is transmitted from person to person (e.g., virus particles released into the air by the sneeze of an infected subject) is the EEV form. On the other hand, variola IMV particles, which are released from lysed infected cells, are transmitted from cell to cell. Thus, antibodies that bind to ELGF (i.e., SPGF and VGF) would likely be particularly useful passive immunoprotectants against initial and/or ongoing infection of a mammalian subject (e.g., a human) by variola or vaccinia.

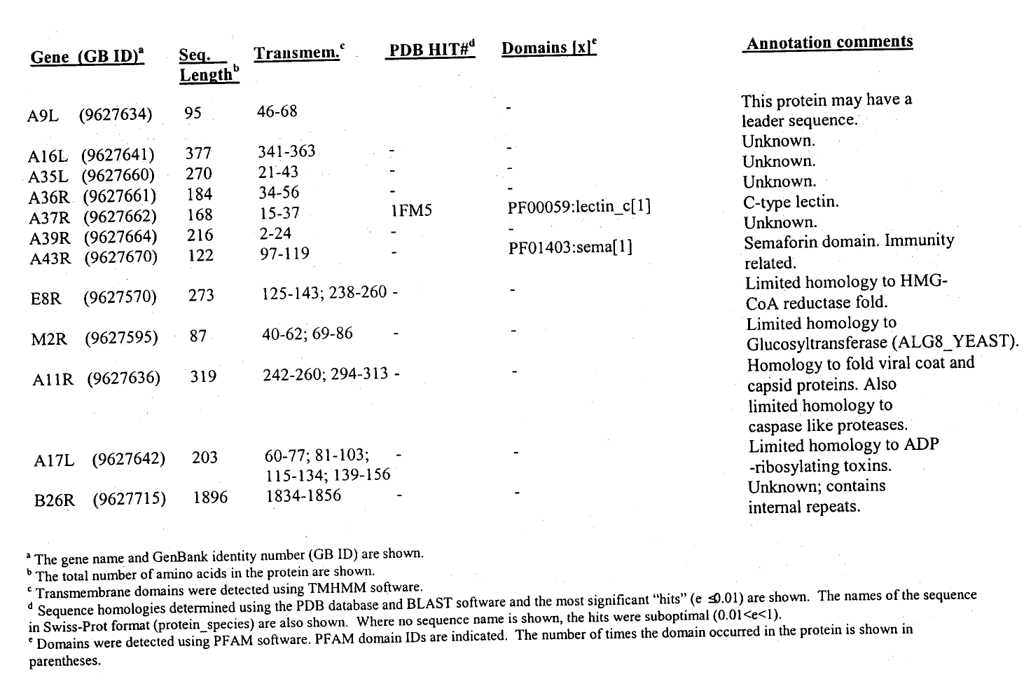

In a first experiment, a group of C57BL/6 (B6) mice (n=5) was injected i.p. with a cocktail containing 200 μg of each of the 11D7, 13E8, and 7D11 monoclonal antibodies. A second group of B6 mice (n=5) was injected i.p. with 600 μg of a control monoclonal antibody (1A3). Six hours later, the mice in both groups were challenged intranasally with an LD₅₀ dose (10⁴ PFU) of vaccinia virus (strain WR). On the ninth day after infection, all mice were sacrificed and the amount of virus in their lungs (in PFU/ml) was measured (FIG. 3). The animals injected with the cocktail of antibodies (mice 6-10) showed a dramatic decrease in viral titer compared with the control mice (mice 1-5). No virus was detectable in the lungs of animals 6, 7, 9, and 10; FIG. 3 indicates that 10² PFU/ml were detected in the lungs of these animals because 10² PFU/ml was the detection limit of the assay. While all the control animals showed severe morbidity starting on day 7 and loss of fat pads, all the experimental animals appeared clinically normal, retained their fat pads, and had no lung pathology at the time of sacrifice.

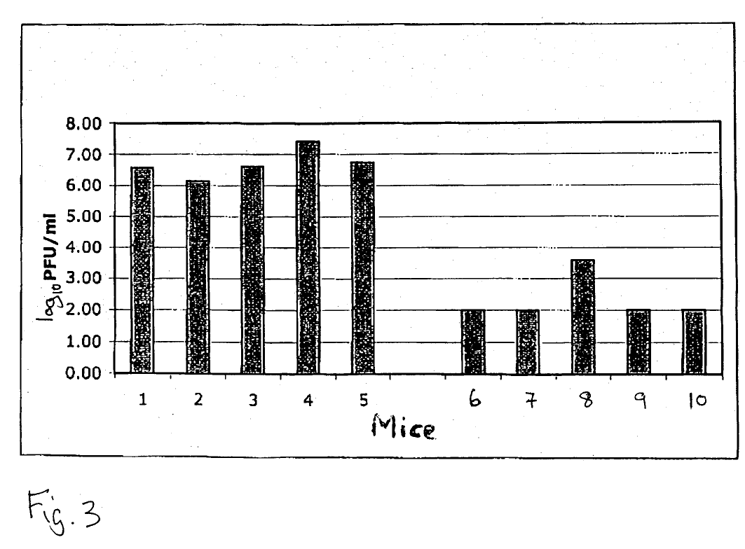

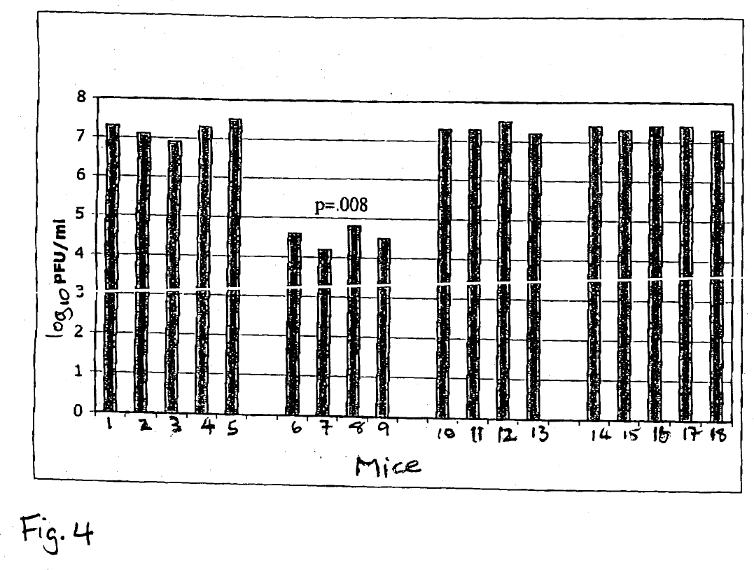

Two additional experiments were carried out using, except where indicated otherwise, conditions identical to those described above. In the second experiment, five mice received control monoclonal antibody alone (mice 1-5), four mice received the L1R specific monoclonal antibody (7D11) alone (mice 6-9), four mice received the 11D7 monoclonal antibody alone (mice 10-13), and five mice received the 13E8 monoclonal antibody alone (mice 14-18) (FIG. 4). Each animal received 200 μg of the relevant monoclonal antibody. The mice were challenged and their lungs assayed for virus as described for the first experiment. When used alone, only the 7D11 antibody significantly (p=0.008) protected mice from infection compared to the control antibody; it reduced the titer of virus detectable in the lungs by about 3 logs.

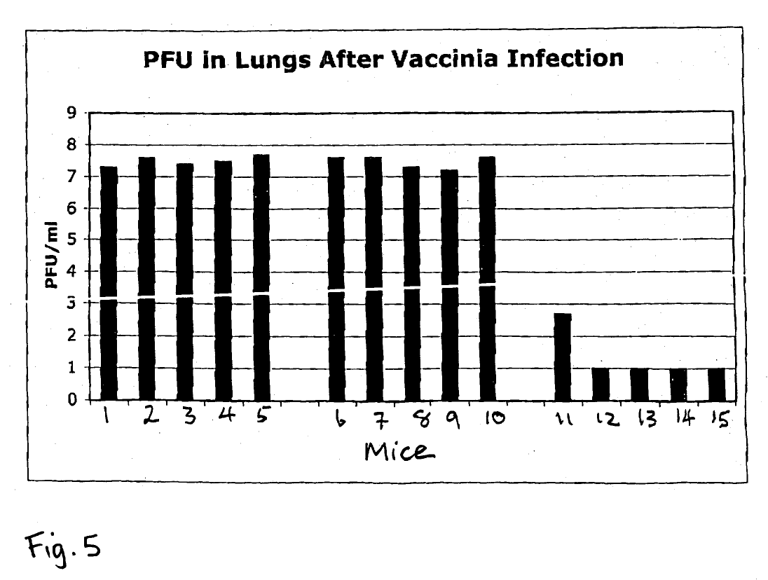

In the third experiment, five mice received no antibody at all (mice 1-5), five mice received the control antibody (200 μg; mice 6-10), and five mice received a cocktail containing 200 μg of each of the 11D7, 13E8, and 7D11 monoclonal antibodies (mice 11-15) (FIG. 5). As in the first experiment, treatment with the cocktail of antibodies resulted in a dramatic decrease (approximately 6 logs) of virus in the lungs of the mice. Moreover, also as in the first experiment, no virus was detectable in the lungs of animals 12-15; FIG. 5 indicates that 10 PFU/ml were detected in the lungs of these animals because 10 PFU/ml was the detection limit in the assay. There was no difference in the titer of virus in the lungs of mice that were injected with control monoclonal antibody compared to mice injected with no antibody at all.

In light of the finding that injection with the 13E8 and 11D7 monoclonal antibodies together with the 7D11 monoclonal antibody (FIGS. 3 and 5) resulted in much greater protection compared to injection of the 7D11 antibody alone (FIG. 4), it seems likely the failure of the 13E8 and 11D7 monoclonal antibodies to protect was due to the very high dose (a LD₅₀ dose) of virus used to challenge the animals and that protection would likely be obtained with either of these antibodies if a lower dose of virus is used. On the other hand, these results also suggest that the concurrent utilization of antibodies that block entry, translocation, or other viral activities may function synergistically to inhibit viral pathogenesis.

A number of embodiments of the invention have been described. It will be understood that various modifications may be made without departing from the spirit and scope of the invention. Accordingly, other embodiments are within the scope of the following claims.

What is claimed is:

1. A computer-based method of identifying an antibody that inhibits infection, the method requiring the use of a programmed computer comprising a processor and an input device, the method comprising:
(a) providing the nucleic acid sequence of a plurality of open reading frames in the genome of an infectious microorganism
(b) inputting to the input device the nucleic acid sequence;
(c) screening the nucleic acid sequence, using the processor, to identify an open reading frame encoding a protein that is predicted to be expressed on the surface of the infectious microorganism;
(d) producing an antibody that binds to the ectodomain of the protein; and
(e) determining whether the antibody inhibits the pathogenicity of the infectious microorganism.

2. A process of manufacturing a compound, the process comprising: carrying out the method of claim 1; and, after determining that the antibody inhibits the pathogenicity of the infectious microorganism, manufacturing a compound comprising at least a portion of the ectodomain.

3. A process of manufacturing an antibody, the process comprising: carrying out the method of claim 1; and, after determining that the antibody inhibits the pathogenicity of the infectious microorganism, manufacturing the antibody.

4. The method of claim 1, wherein the open reading frame is identified as encoding a protein expressed on the surface of the infectious microorganism by a process comprising detecting, in the open reading frame, a nucleotide sequence encoding a putative transmembrane region.

5. The method of claim 4, wherein the process further comprises detecting, in the open reading frame, a nucleotide sequence encoding a putative signal peptide.

6. The method of claim 1, wherein the open reading frame is identified as encoding a protein expressed on the surface of the infectious microorganism by detecting, in the open reading frame, a nucleotide sequence encoding a glycosylphosphatidyl inositol (GPI) linkage site.

7. The method of claim 1, wherein the antibody is produced by immunizing an animal with a polypeptide comprising the ectodomain of the protein.

8. The method of claim 1, wherein the antibody is produced by immunizing an animal with cells transfected or transduced with a nucleic acid encoding a polypeptide comprising the ectodomain of the protein.

9. The method of claim 1, wherein the antibody is a monoclonal antibody.

10. The method of claim 1, wherein the antibody is a polyclonal antibody.

11. The method of claim 1, wherein the infectious microorganism is a virus.

12. The method of claim 11, wherein the virus is variola major virus.

13. The method of claim 11, wherein the virus is variola minor virus.

14. The method of claim 11, wherein the virus is vaccinia virus.

15. The method of claim 11, wherein the virus is selected from the group consisting of hepatitis virus A-E, human papilloma virus, human immunodeficiency virus 1, human T cell lymphotropic virus 1, Herpes virus, Dengue virus 1-4, Ebola virus, Marburg virus, Lassa virus, Machupo virus, and influenza virus.

16. The method of claim 1, wherein the infectious microorganism is a bacterium.

17. The method of claim 16, wherein the bacterium is Mycobacterium tuberculosis.

18. The method of claim 16, wherein the bacterium is Mycobacterium leprae.

19. The method of claim 16, wherein the bacterium is a Salmonella bacterium.

20. The method of claim 19, wherein the Salmonella bacterium is Salmonella typhimurium or Salmonella typhi.

21. The method of 16, wherein the bacterium is Yersinia pestis.

22. The method of claim 1, wherein the infectious microorganism is a protozoan parasite.

23. The method of claim 22, wherein the protozoan parasite is a malarial parasite.

24. The method of claim 22, wherein the protozoan parasite is Leishmania.

25. A compound manufactured by the process of claim 2.

26. A method of inducing an immune response in an animal, the method comprising performing steps (a)-(e) of claim 1 and, after determining that the antibody inhibits pathogenicity of the infectious microorganism, administering a compound comprising at least a portion of the ectodomain to an animal susceptible to infection with the infectious microorganism.

27. The method of claim 26, wherein the immune response is a protective immune response.

28. The method of claim 26, wherein the compound is administered parenterally to the animal.

29. The method of claim 26, wherein the compound is administered to the animal intranasally, transcutaneously, or orally.

30. A method of treatment, the method comprising performing steps (a)-(e) of claim 1 and, after determining that the antibody inhibits pathogenicity of the infectious microorganism, administering the antibody to an animal.

31. An antibody manufactured by the process of claim 3.

32. The method of claim 8, wherein the cells express the polypeptide on their surfaces.

33. The method of claim 8, wherein the cells secrete the polypeptide.

34. The method of claim 16, wherein the bacterium is selected from the group consisting of Bacillus anthracis, Clostridium botulinum, Francisella tularensis, Corynebacterium diphtheriae, Vibrio cholerae, and Escherichia coli.

35. The method of claim 30, wherein the infectious microorganism is a virus.

36. The method of claim 35, wherein the virus is an orthopox virus.

37. The method of claim 35, wherein the orthopox virus is a variola virus.

38. The method of claim 35, wherein the orthopox virus is a vaccinia virus.

39. The method of claim 36, wherein the protein is a smallpox growth factor (SPGF) or a VGF (vaccinia growth factor).

40. The method of claim 30, wherein the antibody is a monoclonal antibody.

41. The method of claim 30, wherein the antibody is a polyclonal antibody.

42. The method of claim 36, wherein the antibody is a monoclonal antibody.

43. The method of claim 42, wherein the monoclonal antibody is the 3D4R-13E8 monoclonal antibody (ATCC Accession No: PTA-5040).

44. The method of claim 42, wherein the monoclonal antibody is the 3D4R-11D7 monoclonal antibody (ATCC Accession No: PTA-5039).

45. A monoclonal antibody that binds to a protein encoded by the genome of variola virus or a vaccinia virus, wherein the protein is a protein that is expressed on the surface of the virus or on the surface of a cell infected with the virus.

46. The monoclonal antibody of claim 45, wherein the protein is a SPGF or a VGF.

47. The monoclonal antibody of claim 46, wherein the monoclonal antibody is the 3D4R-13E8 monoclonal antibody (ATCC Accession No: PTA-5040).

48. The antibody of claim 46, wherein the monoclonal antibody is the 3D4R-11D7 monoclonal antibody (ATCC Accession No: PTA-5039).

49. A humanized antibody derived from the antibody of claim 47.

50. A humanized antibody derived from the antibody of claim 48.

51. The method of claim 30, further comprising administering to the animal one or more additional antibodies, wherein the one or more additional antibodies bind to a protein encoded by the infectious microorganism.

52. The method of claim 36, further comprising administering to the animal one or more additional antibodies, wherein the one or more additional antibodies bind to a protein encoded by the orthopox virus.

53. The method of claim 52, wherein the one or more additional antibodies is the 3D4R-13E8 monoclonal antibody (ATCC Accession No.: PTA-5040) or the 3D4R-11D7 monoclonal antibody (ATCC Accession No: 5039).
